(19) United States
(12) Patent Application Publication
(10) Pub. No.: US 2011/0251759 A1
(43) Pub. Date: Oct. 13, 2011

(54) DEVICE AND METHOD FOR DETERMINING A ROADWAY COEFFICIENT OF FRICTION FOR A VEHICLE

(75) Inventors: Georg Mack, Eberdingen (DE); Johannes Weichert, Leonberg (DE)

(73) Assignee: Dr. Ing. h.c. F. Porsche Aktiengesellschaft, Stuttgart (DE)

(21) Appl. No.: 13/082,892

(22) Filed: Apr. 8, 2011

(30) Foreign Application Priority Data
Apr. 10, 2010 (DE) 102010014564.5

(51) Int. Cl. B62D 6/00

(52) U.S. Cl. 701/42; 701/41

(57) ABSTRACT

A device for determining a roadway coefficient of friction for a vehicle, having a first tire steering device for setting a first predetermined steering angle (α₁) of a first tire of the vehicle; a second tire steering device for setting a second predetermined steering angle (α₂) of a second tire of the vehicle; a first sensor device for sensing a force necessary for setting the first predetermined steering angle (α₁) of the first tire; a second sensor device for sensing a force necessary for setting the second predetermined steering angle (α₂) of the second tire; and an evaluation device for determining the roadway coefficient of friction by evaluating the acquired data of the first and second sensor devices using a predetermined algorithm. Also, a method for determining a roadway coefficient of friction.

### CROSS REFERENCE TO RELATED APPLICATION

This U.S. patent application claims priority to German Patent Application DE 10 2010 014 564.6, filed Apr. 10, 2010, which is incorporated by reference herein in its entirety.

### FIELD OF INVENTION

The present invention relates to a device and a method for determining a roadway coefficient of friction for a vehicle.

### BACKGROUND OF THE INVENTION

Although the present invention can be applied to any vehicles, the present invention and the problems on which it is based will be explained in more detail with reference to a passenger car.

Information about the instantaneous roadway coefficient of friction or the state of the road paving are highly significant for active driving stability systems in motor vehicles. For this reason, every electronic stability program has, for example, an internal coefficient of friction estimation device. However, in the case of high friction values, for example when the vehicle is braking or being driven, said coefficient of friction estimation device can obtain definitive information about the roadway coefficient of friction only relatively rarely. In all other driving situations, the information about the roadway coefficient of friction is very imprecise. There are therefore approaches to solutions to enable the coefficient of friction also to be determined in other driving situations so that the availability of up-to-date roadway coefficient of friction values for dynamic driving stability systems can be increased.

JP 10288559, which is incorporated by reference, describes a device for estimating a roadway coefficient of friction. In this context, a motor vehicle has an electro-mechanical rear axle steering system in which the two rear wheels of the motor vehicle are coupled mechanically to one another by means of a control rod. An electric actuator is provided for moving the control rod transversely with respect to the longitudinal direction of the vehicle, thereby moving both rear wheels simultaneously with a predetermined steering angle. The force for setting the predetermined steering angle can be determined indirectly from the power consumption of the actuator. The roadway coefficient of friction is directly proportional to the determined force and can be calculated by an evaluation unit by means of a predetermined algorithm.

However, it has proved disadvantageous with this arrangement that both tires are coupled mechanically to one another. It is therefore not possible to determine a roadway coefficient of friction at both tires independently of one another, for example in order to maintain the functionality of the device when the actuator fails, or in order to check the plausibility of the determined roadway coefficient of friction value on the basis of two roadway coefficient of friction values which are determined independently of one another at the two wheels. Furthermore, a high power consumption level of the actuator is brought about as a result of the fact that both tires always have to be adjusted simultaneously, and therefore an adjustment force has to be applied at both tires. Furthermore, depending on the velocity, the setting of the predetermined steering angle can be clearly felt by a vehicle driver during a simultaneous positioning of the two rear wheels.

The present invention is therefore based on the object of providing an improved device and an improved method for determining a roadway coefficient of friction for a vehicle which overcome the abovementioned disadvantages.

### SUMMARY OF THE INVENTION

This object is achieved according to aspects of the invention by a device having the features of patent claim 1 and/or by a method having the features of patent claim 8.

Accordingly, the following are provided:

A device for determining a roadway coefficient of friction for a vehicle having a first tire steering device for setting a first predetermined steering angle of a first tire of the vehicle; second tire steering device for setting a second predetermined steering angle of a second tire of the vehicle; a first sensor device for sensing a force which is necessary for setting the first predetermined steering angle of the first tire; a second sensor device for sensing a force which is necessary for setting the second predetermined steering angle of the second tire; and an evaluation device for determining the roadway coefficient of friction by evaluating the acquired data of the first and second sensor devices using a predetermined algorithm.

A method for determining a roadway coefficient of friction for a vehicle, having the following method steps: setting of a first predetermined steering angle of a first tire of the vehicle by means of a first tire steering device; setting of a second predetermined steering angle of a second tire of the vehicle by means of a second tire steering device; sensing of a force which is necessary for setting the first predetermined steering angle of the first tire, by means of a first sensor device; sensing of a force which is necessary for setting the second predetermined steering angle of the second tire, by means of a second sensor device; and determination of the roadway coefficient of friction by evaluating the acquired data of the first and second sensor devices using a predetermined algorithm by means of an evaluation device.

The basic idea of the present invention is to provide a separate first and second tire steering device for setting a first and a second predetermined steering angle at two tires of a vehicle, as a result of which there is no need for mechanical coupling of the two tires.

The present invention therefore has the advantage over the prior art that a mechanical coupling of the tires is dispensed with. As a result, the steering angles can be set independently of one another, allowing the influence of the steering angle setting on the driving behavior of the vehicle to be influenced advantageously.

The subclaims contain advantageous refinements and improvements of the device specified in patent claim 1 and of the method specified in patent claim 8.

According to one preferred development, the first and second tire steering devices each have an electric motor for setting the first and second predetermined steering angles. This ensures that the predetermined steering angles can be set reliably with a small space requirement, as a result of which the field of use of the device can be advantageously expanded.

According to a further preferred exemplary embodiment, the first and second sensor devices each have a current measuring device for measuring electric current which is present at the respective electric motor. As a result, the force for setting the predetermined steering angles can be determined indirectly in a quick and comfortable way. A costly force measuring device, for example in the form of strain gages, can advantageously be dispensed with.

According to a further preferred development, the first and second current measuring devices are each embodied as integral components of the respective electric motor, which advantageously results in a reduced space requirement for the device. This expands the possible field of use of the device.

According to a further preferred embodiment, the first and second steering devices for setting the first and second predetermined steering angles each have a ball screw for converting rotational movements of the respective electric motor into translational movements. This is a convenient way of providing a transmission means which enables the overall size of the electric motors which is as small as possible to be advantageously selected. Furthermore, instead of costly linear motors, more favorable electric motors with a rotational movement can be used, permitting the production costs of the device to be advantageously reduced.

According to a further preferred development, the first and second tire steering devices are each embodied as components of an electro-mechanical axle steering system, in particular of an electro-mechanical rear axle steering system, of the vehicle. This advantageously permits the roadway coefficient of friction to be determined independently of steering movements of a vehicle driver at the front axle.

According to a further preferred exemplary embodiment, the device has an actuation device for actuating the first and second tire steering devices, wherein the first and second predetermined steering angles can be set independently of one another. This advantageously permits, for example, redundant determination of the roadway coefficient of friction, allowing the reliability of the device to be increased.

According to a further preferred development, the determination of the roadway coefficient of friction is carried out in a stationary state of the vehicle and/or at a low speed of the vehicle, as a result of which the influence of the setting of predetermined steering angles on the driving behavior of the vehicle is reduced to a minimum. This increases the driving comfort.

According to a further preferred embodiment, the first and second predetermined steering angles are set in a way which is imperceptible to a vehicle driver. This also increases the driving comfort for the vehicle driver.

According to a further preferred development, the current roadway coefficient of friction is determined continuously, as a result of which the informativeness and the reliability of the method are significantly increased.

According to one preferred embodiment, the first predetermined steering angle is set by means of a first electric motor of the first tire steering device, and the second predetermined steering angle is set by means of a second electric motor of the second tire steering device. This ensures that the predetermined steering angles can be set reliably with a small space requirement, as a result of which the field of use of the method is advantageously expanded.

According to a further preferred embodiment, in order to sense the necessary forces for setting the first and second predetermined steering angles by means of a first current measuring device of the first sensor device at the first electric motor and by means of a second current measuring device of the second sensor device at the second electric motor, an electric current which is present at the respective electric motor is measured, wherein the first and second current measuring devices are integrated, in particular, into the respective electric motor. This quickly and reliably permits, with a small space requirement, indirect determination of the necessary forces for setting the predetermined steering angles, as a result of which the method is simplified.

According to a further preferred development, the first and second predetermined steering angles have identical steering angle values and/or identical steering angle directions, wherein, in particular in addition to a roadway coefficient of friction which is determined for the first or second tire, a further roadway coefficient of friction is determined on the other tire for the purpose of plausibility checking or for redundancy. As a result, on the one hand, the plausibility checking increases the informativeness of the roadway coefficient of friction which is determined. On the other hand, given the redundant determination of two roadway coefficient of friction values, a roadway coefficient of friction value continues to be determined even if one of the tire steering devices fails, as a result of which the reliability and the fault tolerance of the method are significantly increased.

According to one preferred embodiment, the first and second predetermined steering angles have different steering angle absolute values and/or different steering angle directions, wherein, in particular, the first or the second predetermined steering angle is equal to zero. As a result, on the one hand, it is advantageously possible to carry out compensation of the influence of the steering angle setting on the tires when steering angles are set in opposite directions, which prevents the rear of a vehicle from fishtailing. On the other hand, when the steering angle is set at just one tire, it is advantageously possible to bring about reduced power consumption and also to reduce the influence on the driving behavior of the vehicle.

### BRIEF DESCRIPTION OF THE DRAWINGS

The invention is best understood from the following detailed description when read in connection with the accompanying drawings. Included in the drawings are the following figures:

FIG. 1 shows an exemplary device for determining a roadway coefficient of friction according to a preferred embodiment of the present invention in a top view;

FIG. 2 shows the device according to FIG. 1 in a further operating state;

FIG. 3 shows the device according to FIG. 1 in an alternative operating state; and

FIG. 4 shows various power drain values plotted against the stroke of an electric motor of a device according to FIG. 1 for various roadway coefficients of friction.

### DETAILED DESCRIPTION OF THE INVENTION

In the figures of the drawing, the same reference signs denote identical or functionally identical components unless otherwise stated.

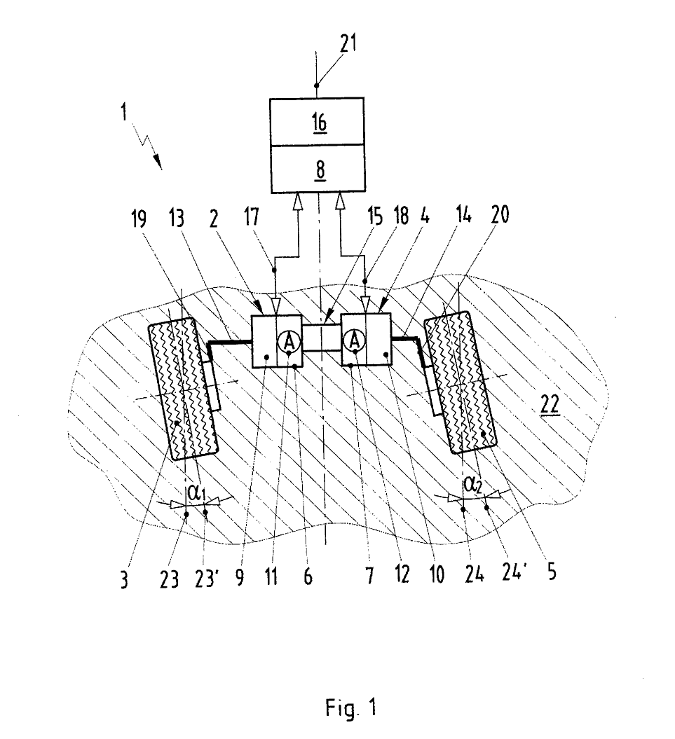

In the text which follows, a preferred exemplary embodiment of the present invention is explained on the basis of FIGS. 1 to 4.

FIG. 1 shows a preferred embodiment of a device 1 for determining a roadway coefficient of friction for a vehicle. The device 1 has a first tire steering device 2 which is assigned to a first tire 3 of the vehicle, and a second tire steering device 4 which is assigned to a second tire 5 of the vehicle. The tires 3, 5 are arranged on a roadway surface 22. Furthermore, the device 1 comprises a first sensor device 6 which is assigned to the first tire steering device 2, and a second sensor device 7 which is assigned to the second tire steering device 4.

The first and second tire steering devices 2, 4 respectively have a first and a second electromotor 9, 10. The electric motors 9, 10 are respectively coupled to the first and second tires 3, 5 by means of first and second ball screws 13, 14. The ball screws 13, 14 serve here to convert rotational movements of the electric motors 9, 10 into translational movements. In order to implement pivoting movements of the tires 3, 5, the ball screws 13, 14 are operatively connected to the first and second tires 3, 5 by means of first and second lever arms 19, 20. Alternatively, the electric linear actuators can also be used to pivot the tires 3, 5.

The first and second sensor devices 6, 7 are preferably embodied as current measuring devices 11, 12, which are an integral component of the first and second electric motors 9, 10. An evaluation device 8 is respectively connected to the first and second tire steering devices 2, 4 by means of a first and a second data line 17, 18. In an alternative embodiment of the device, a common data line serves for connecting the evaluation device 8 to the tire steering devices 2, 4. An actuation device 16, which is preferably an integral component of the evaluation unit 8, is also coupled by means of the data lines 17, 18 to the first and second tire steering devices 2, 4.

The actuation device 16 serves to actuate the electric motors 9, 10 which set a first and a second predetermined steering angle α₁, α₂ at the first and second tires 3, 5 by means of the ball screws 13, 14 and the lever arms 19, 20. The tires 3, 5 are therefore not coupled mechanically to one another. For the purpose of clarification, the first and second predetermined steering angles α₁, α₂ are illustrated in FIG. 1 with a significantly larger steering angle absolute value than would actually be the case during operation of the device 1. The absolute values of the steering angles α₁, α₂ are respectively measured between a first and a second tire centerline 23, 24, running parallel to a vehicle longitudinal axis 21, of the first and second tires 3, 5, and a first and second positioned tire centerline 23′, 24′ of the first and second tires 3, 5. The first and second tire steering devices 2, 4 are preferably components of an electro-mechanical axis steering system, in particular of an electro-mechanical rear axle steering system, wherein the first and second tires 3, 5 are arranged on opposites sides of a vehicle axle.

In one alternative embodiment of the device 1, the device has just one of the two tire steering devices 2, 4. This permits the roadway coefficient of friction value to be determined with significantly reduced structural complexity and with reduced power consumption since then just one electric motor 9, 10 is provided.

The function of the device 1 is explained below using the example of a preferred operating state of the device 1. In order to determine a roadway coefficient of friction, the first and second tire steering devices 2, 4 are activated by the control device 16 in order to set a first predetermined steering angle α₁ at the first tire 3, and a second predetermined steering angle α₂ at the second tire 5. In this context, the first and second predetermined steering angles α₁, α₂ have an identical steering angle absolute value and an identical steering angle direction, i.e. the tires 3, 5 are pivoted to the same extent in the same direction with respect to the tire centerlines 23, 24.

During the setting of the predetermined steering angles α₁, α₂, the rotational movement of the electric motors 9, 10 is converted into a translational movement by means of the ball screws 13, 14. This translational movement is converted, by means of the lever arms 19, 20, into a steering movement of the tires 3, 5 until the desired steering angles α₁, α₂ are set. The setting of the steering angles α₁, α₂ is preferably carried out when the vehicle starts or stops. Alternatively, the steering angles α₁, α₂ can also be set while the vehicle is traveling.

The current measuring devices 11, 12 of the first and second tire steering devices 2, 4 measure, during the setting of the first and second steering angles α₁, α₂, the electric currents which are taken up by the electric motors 9, 10. The greater the necessary force to set the steering angles α₁, α₂, the larger the currents which are required by the electric motors 9, 10. The evaluation device 8 is therefore able to infer indirectly the necessary forces for setting the steering angles α₁, α₂ from the determined electric currents of the electric motors 9, 10.

For the stationary vehicle, the evaluation device 8 uses, for example, the following algorithms to determine a roadway coefficient of friction value μ:

$${M}_{pivot} ∼ μ \frac{{F}_{z}^{1.5}}{{p}^{0.5}}$$

where Mₚᵢᵥₒₜ is the pivoting torque, F_{z}, is the wheel load and p is the tire pressure. The pivoting torque Mₚᵢᵥₒₜ is the necessary torque to set a predetermined steering angle α₁, α₂. Mₚᵢᵥₒₜ is here the product of the length of the lever arm 19, 20 and the force necessary to set the steering angle α₁, α₂. The length of the lever arms 19, 20 is known. The necessary force to set the steering angle α₁, α₂ can be determined indirectly from the determined power drain of one of the electric motors 9, 10. The wheel load F_{z}, is made available by a wheel load estimating device. The tire pressure p is determined by a tire pressure monitoring system of the vehicle. Together with other sensor information such as, for example, the external temperature and the air humidity it is possible to infer the state of the roadway.

Since the first and second predetermined steering angles α₁, α₂ of the first and second tires 3, 5 are of equal magnitude, it is possible, assuming that the same roadway coefficient of friction is present at each tire 3, 5, to carry out redundant checking of the determined roadway coefficient of friction. As a result, the functionality of the device 1 can be reliably ensured even when one of the tire steering devices 2, 4 fails. Furthermore, plausibility checking of the determined roadway coefficient of friction can be carried out by virtue of the fact that a tire steering device 2, 4 is provided at the two wheels 3, 5. The roadway coefficient of friction which is determined at a tire 3, 5 is compared with the roadway coefficient of friction which is determined at the other tire 3, 5. If the values of the roadway coefficient of friction then differ too much from one another, the measurement can, for example, be repeated.

The determination of the roadway coefficient of friction is preferably carried out in a way which is imperceptible to a vehicle driver, for example when the vehicle starts, when it stops at a traffic light or during slow travel. Alternatively, the determination of the roadway coefficient of friction can also take place continuously, for example in a predefined time interval.

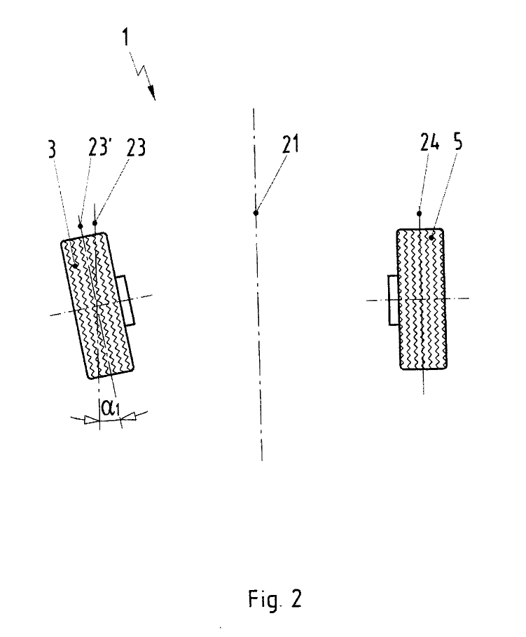

FIG. 2 shows a further preferred operating state of the device 1. For the sake of simplified illustration, FIG. 2 shows only the tires 3, 5 with the respective steering angles α₁, α₂. In the operating state of the device 1 according to FIG. 2, the first and second steering angles α₁, α₂ have different steering angle absolute values. In particular, the first predetermined steering angle α₁ is set only at the first tire 3. The second tire steering device 4 is inactive, that is to say, the second predetermined steering angle α₂ is equal to zero. Alternatively, it is also possible for the second steering angle α₂ to be set at the second tire 5 and for the first steering device 2 to be inactive. For example, the determination of the roadway coefficient of friction takes place alternately at the first and second tires 3, 5.

The operating state of the device 1 which is illustrated in FIG. 2 has the advantage that a predetermined steering angle α₁, α₂ has to be set only at the tire 3 or 5, as a result of which the energy consumption of the electric motors 9, 10 for setting the predetermined steering angles α₁, α₂ is reduced. Furthermore, this arrangement has the advantage that the setting of a steering angle α₁ at just one tire 3 is less perceptible to a vehicle driver than the simultaneous setting of a steering angle α₁, α₂ a at both tires 3, 5.

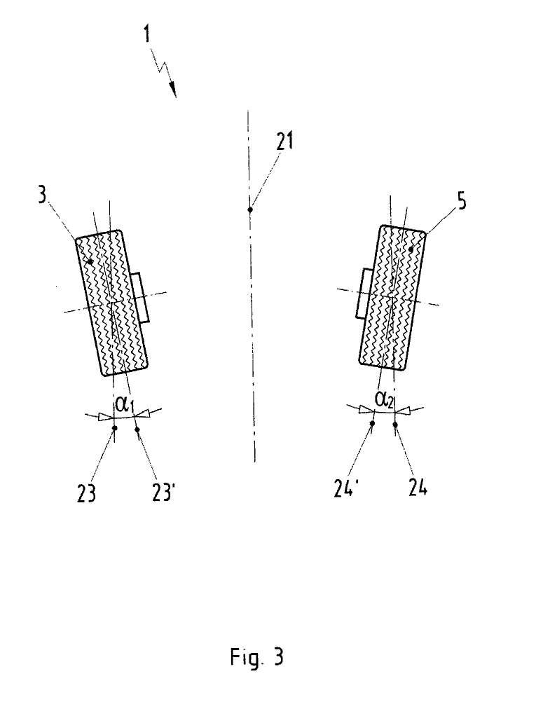

FIG. 3 shows a further alternative operating state of the device 1. Here, the first predetermined steering angle α₁ and the second predetermined steering angle α₂ have an identical steering angle absolute value but the first and second tires 3, 5 are positioned in opposing steering angle directions. This provides the advantage that a possible movement of the vehicle as a result of the opposed positioning of the tires 3, 5 is compensated for. For example, this prevents fishtailing of the rear part of the vehicle and thereby increases the driving comfort for the vehicle driver.

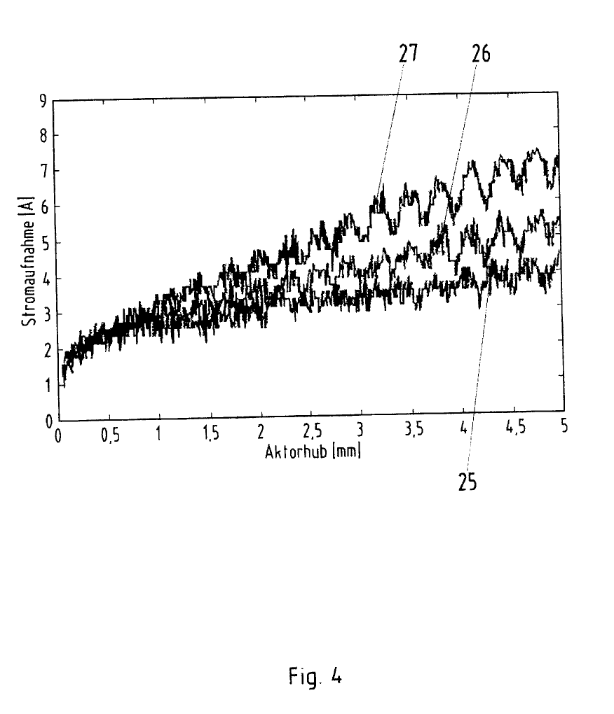

FIG. 4 shows by way of example the influence of the set predetermined steering angles α₁, α₂ on the power consumption of the electric motors 9, 10 on roadways with different surface conditions. Here, the stroke which is generated by one of the electric motors 9, 10, which is directly proportional to the predetermined steering angle α₁, α₂ᵣ is given in millimeters on the x axis of the graph. The current which is determined by one of the current measuring devices 11, 12 is plotted in amperes on the y axis. The curve 25 corresponds to a roadway surface composed of gravel, the curve 26 corresponds to a roadway surface composed of wet asphalt, and the curve 27 corresponds to a roadway surface composed of dry asphalt.

All three curves 25, 26, 27 initially rise continuously until they virtually asymptotically approach a maximum power consumption level. It can be clearly seen here that the curves differ significantly in the power consumption from, at the latest, an actuator stroke of 2.5 mm. The lowest power consumption can be seen in the case of the gravel surface, illustrated by the curve 25, with the lowest roadway coefficient of friction, while in the case of dry asphalt, illustrated by the curve 27, the power consumption is almost twice as high for the same actuator stroke. The curve 26, which illustrates the wet asphalt, is between the curves 25, 27 for the gravel surface and the dry asphalt.

1.-15. (canceled)

16. A device for determining a roadway coefficient of friction for a vehicle, having: a first tire steering device for setting a first predetermined steering angle (α₁) of a first tire of the vehicle;
a second tire steering device for setting a second predetermined steering angle (α₂) of a second tire of the vehicle;
a first sensor device for sensing a force which is necessary for setting the first predetermined steering angle (α₁) of the first tire;
a second sensor device for sensing a force which is necessary for setting the second predetermined steering angle (α₂) of the second tire; and
an evaluation device for determining the roadway coefficient of friction by evaluating acquired data of the first and second sensor devices using a predetermined algorithm.

17. The device as claimed in claim 16, wherein the first and second tire steering devices each have an electric motor for setting the first and second predetermined steering angles (α₁, α₂).

18. The device as claimed in claim 17, wherein the first and second sensor devices each have a current measuring device for measuring electric current which is present at the respective electric motor.

19. The device as claimed in claim 18, wherein the first and second current measuring devices are each embodied as integral components of the respective electric motor.

20. The device as claimed in claim 17, wherein the first and second steering devices for setting the first and second predetermined steering angles (α₁, α₂) each have a ball screw for converting rotational movements of the respective electric motor into translational movements.

21. The device as claimed in claim 16, wherein the first and second tire steering devices are each embodied as components of an electro-mechanical axle steering system, in particular of an electro-mechanical rear axle steering system, of the vehicle.

22. The device as claimed in claim 16, wherein the device has an actuation device for actuating the first and second tire steering devices, wherein the first and second predetermined steering angles (α₁, α₂) can be set independently of one another.

23. A method for determining a roadway coefficient of friction for a vehicle, having the following method steps:
setting of a first predetermined steering angle (α₁) of a first tire of the vehicle by means of a first tire steering device;
setting of a second predetermined steering angle (α₂) of a second tire of the vehicle by means of a second tire steering device;
sensing of a force which is necessary for setting a first predetermined steering angle (α₁) of the first tire, by means of a first sensor device;
sensing of a force which is necessary for setting the second predetermined steering angle (α₂) of the second tire, by means of a second sensor device; and
determination of the roadway coefficient of friction by evaluating the acquired data of the first and second sensor devices using a predetermined algorithm by means of an evaluation device.

24. The method as claimed in claim 23, wherein the determination of the roadway coefficient of friction is carried out in a stationary state of the vehicle and/or at a low speed of the vehicle.

25. The method as claimed in claim 23, wherein the first and second predetermined steering angles (α₁, α₂) are set in a way which is imperceptible to a vehicle driver.

26. The method as claimed in claim 23, wherein the current roadway coefficient of friction is determined continuously.

27. The method as claimed in claim 23, wherein the first predetermined steering angle (α₁) is set by means of a first electric motor of the first tire steering device, and the second predetermined steering angle (α₂) is set by means of a second electric motor of the second tire steering device.

28. The method as claimed in claim 27, wherein, in order to sense the necessary forces for setting the first and second predetermined steering angles (α₁, α₂) by means of a first current measuring device of the first sensor device at the first electric motor and by means of a second current measuring device of the second sensor device at the second electric motor, an electric current which is present at the respective electric motor is measured, wherein the first and second current measuring devices are integrated, in particular, into the respective electric motor.

29. The method as claimed in claim 23, wherein the first and second predetermined steering angles (α₁, α₂) have identical steering angle absolute values and/or identical steering angle directions, wherein, in particular in addition to a roadway coefficient of friction which is determined for the first or second tire, a further roadway coefficient of friction is determined on the other tire for the purpose of plausibility checking or for redundancy.

30. The method as claimed in claim 23, wherein the first and second predetermined steering angles (α₁, α₂) have different steering angle absolute values and/or different steering angle directions, wherein, in particular, the first or the second predetermined steering angle (α₁, α₂) is equal to zero.
